(19) United States
(12) Patent Application Publication
(10) Pub. No.: US 2022/0277362 A1
(43) Pub. Date: Sep. 1, 2022

(54) REAL-TIME RECOMMENDATION OF DATA LABELING PROVIDERS

(71) Applicant: Alectio, Inc., Santa Clara, CA (US)

(72) Inventor: Jennifer Laetitia Prendki, Mountain View, CA (US)

(21) Appl. No.: 17/681,445

(22) Filed: Feb. 25, 2022

Related U.S. Application Data
(60) Provisional application No. 63/154,189, filed on Feb. 26, 2021.

(51) Int. Cl. G06Q 30/02; G06N 5/02

(52) U.S. Cl. CPC G06Q 30/0282; G06Q 30/0201; G06N 5/022

(57) ABSTRACT

A method of automatically recommending partners to label machine learning datasets by receiving a dataset to be labeled and labeling instructions; storing in a database real-time performance values for labeling partners in a labeling marketplace, the values being updated as the partners complete labeling tasks for training data for machine learning models and transmit the metrics from the labeling partners to the system; determining a type of data of the user dataset and a type of labeling task; identifying, from among the partners, a subset of partners that can label the data or perform the labeling task; querying the metrics to select a selected labeling partner optimal to the task; transmitting the data and instructions to the selected partner; receiving a labeled dataset from the selected partner; evaluating a quality of the labeled dataset and updating the database to specify the quality; transmitting the labeled data to the user.

### BENEFIT CLAIM

This application claims the benefit under 35 U.S.C. § 119(e) of provisional application 63/154,189, filed Feb. 26, 2021, the entire contents of which are hereby incorporated by reference for all purposes as if fully set forth herein.

### COPYRIGHT NOTICE

The disclosure contains material which is subject to copyright protection. The patent owner has no objection to the reproduction of this document as it appears in Patent and Trademark Office records, but otherwise reserves all rights. Copyright © 2021-2022 Alectio, Inc.

### FIELD OF THE DISCLOSURE

One technical field is computer-implemented labeling of datasets for use in supervised machine learning (ML) processes. Another technical field is automated data labeling processes. Another technical field is computer-implemented recommendations of service providers.

### BACKGROUND

The approaches described in this section could be pursued but are not necessarily approaches that have been previously conceived or pursued. Therefore, unless otherwise indicated herein, the approaches described in this section are not prior art to the claims in this application and are not admitted to be prior art by inclusion in this section.

Supervised Machine Learning training processes consist of a training phase during which labeled training data is used to fit a model to that data and learn the parameters of that model, followed by a validation phase used for tuning the model, and a test phase used to measure the final performance of the model. All those phases require high quality data in order to generalize properly, since any defect in the training data could cause dramatic defects in the learning process and result in biases or low accuracy.

In many modern applications, such as but not limited to image or text classification, object detection, semantic or instance segmentation, named entity extraction, and machine translation or transcription, the data requires the acquisition (usually manual) of labels or annotations, as ground truth information is necessary for Machine Learning algorithms to associate a data record (such as, for example, an image) to the concept to be predicted (such as the location of specific classes of objects in that image in the case of object detection).

Labeling services and platforms are available for that purpose and have grown in popularity as the size of the datasets used by ML scientists keep growing at an accelerated pace and it is becoming increasingly challenging for ML teams to perform labeling/annotation tasks in-house. In spite of fast adoptions of such services, the customers of those labeling companies are usually dissatisfied with the work output, for reasons ranging from high costs to large delays in delivery or low labeling accuracy. It is, in fact, very common for such customers to switch labeling providers regularly following accrued frustration, with unfortunately very little guidance as per what labeling company might be most appropriate for their situation and use case.

Labeling companies mostly rely on human annotators to provide those services; sometimes those people are directly employed by the labeling companies (this is called the managed services model), and sometimes the labeling is distributed through crowdsourcing. In both cases, the ability of the labeling company to deliver quality results is highly dependent on the performance of the people it employs (e.g., annotators), the real-time availability of the right annotators (who might be busy on other tasks), and its ability to find, hire, train and provide feedback to them. For example, if a large company hires the services of a labeling company for a very high volume labeling task that involves Computer Vision, then it is highly possible that many of the annotators with sufficient knowledge in Computer Vision will not be available for anew task sent by a second company that also involves a task in Computer Vision. If the labeling company nonetheless accepts the new task from the second company, both of the completed tasks may suffer from inferior quality (e.g., lower labeling accuracy).

Labeling companies sometimes focus on a few types of annotation tasks (for example, solely on Computer Vision or Translation), but also very frequently offer a wide range of different types of annotations; even in the latter case, they often do better at their core competency, as the labeling accuracy would depend on the specialization of their task force. The labeling companies' pricing models also vary dramatically from one company to another. In some cases, labeling companies charge on a record basis, meaning that even if a record consists of an image with no object of interest on it, the customer will still be charged for the annotation (or, in this case, the absence thereof). In other cases, customers may be charged based on a number of objects' classes, or the number of objects, etc.

More and more companies involved in ML have started exploring solutions to replace the traditional manual labeling processes by looking into automated processes, which may involve using pre-trained models. Such solutions are in fact increasingly appearing as part of the labeling services provided by third-party companies. However, automated labeling processes typically result in much lower labeling accuracies, and hence often require human interventions to validate or correct problematic labels. Measuring labeling accuracy in such a case is even harder than it would be if manual labeling processes were used since it becomes difficult to identify where the problem lies (e.g., does the problem come from incorrectly labeled data or was the model incorrectly trained). Automatic labeling processes also suffer from the circular problem that if a machine learning model is to be used to generate synthetic labels, then the model first needs to be trained on a labeled dataset, but a labeled dataset of adequate size cannot be created without generating synthetic labels first.

Building accurate ML models requires labeling fairly large amounts of data, and the solutions available on the market are typically expensive, slow, time-consuming, and generally fall short of the customer's expectations by producing work of inferior quality (e.g., lower labeling accuracy, slow turn-around time). Customers typically end up jumping from one provider to another due to failed expectations, and without a guarantee that the next provider will be able to better results.

Each labeling company has its own strengths and weaknesses: some might have more experienced annotators for translation tasks; some might have less annotators but have their workforce distributed around the globe; others might have better tooling at their disposal which make the generation of accurate labels faster. Given the specialized nature of the various labeling tasks, it is extremely difficult for any single labeling company to be generalized to handle all types of labeling tasks. Instead, labeling companies typically specialize to handle specific types of tasks or specialize to handle certain types of circumstances (e.g., faster turnaround time, even at some cost of lower labeling accuracy).

### SUMMARY OF THE INVENTION

The appended claims may serve as a summary of the invention.

### BRIEF DESCRIPTION OF DRAWINGS

In the drawings:

FIG. 1 is a flowchart that illustrates the system's processes for labeling a customer's data, which includes the selection process for identifying a labeling partner suitable for the task and the quality control process for evaluating the quality of the labeled data.

FIG. 2 is a flowchart that illustrates the system's processes for labeling a customer's data using a data preparation system with a data curation engine.

FIG. 3 is an example network of distributed computers that can form one environment or context for an embodiment.

FIG. 4 is a block diagram that illustrates an example computer system with which an embodiment may be implemented.

FIG. 5A illustrates a computer display device that is displaying an example of a graphical user interface with which a customer can provide information about its data labeling requirements to the computer system of an embodiment.

FIG. 5B illustrates a computer display device that is displaying an example of a graphical user interface providing an analytical dashboard to report performance statistics and metrics for a labeling partner.

FIG. 5C illustrates a computer display device that is displaying an example of a graphical user interface providing bar graphs of market share of labeling partners and which may form a portion of a larger interface that includes FIG. 5B, FIG. 5D.

FIG. 5D illustrates a computer display device that is displaying an example of a graphical user interface providing machine-generated graphical diagrams of statistical data relating to a labeling partner and which may form a portion of a larger interface that includes FIG. 5B, FIG. 5C.

FIG. 5E illustrates a computer display device that is displaying an example of a graphical user interface with which a labeling partner can provide information about its data labeling capabilities to the computer system of an embodiment.

FIG. 5F illustrates a computer display device that is displaying an example of a graphical user interface with which a customer can select one or more labeling partners and view recommendations of labeling partners.

FIG. 6A illustrates an example of a graphical user interface with input widgets that can be programmed to implement a point allocation system.

FIG. 6B illustrates an example of a graphical user interface that can be programmed as presentation output of an ordered set of recommended labeling partners.

FIG. 7 is a screenshot of how users control how validation/QA is done for their data.

FIG. 8 illustrates an example graphical user interface output screen display of a Human-in-the-Loop module.

### DETAILED DESCRIPTION OF EXAMPLE EMBODIMENTS

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

Embodiments are described in sections according to the following outline:

1. EXAMPLE DISTRIBUTED COMPUTER SYSTEM ENVIRONMENT
1.1 COMPUTER SYSTEM OVERVIEW
1.2 INTEGRATION OF RECOMMENDATION PROCESSES WITH OTHER SYSTEMS
1.3 PRELIMINARY TASK FILTER
1.4 COLLECTED METADATA AND OPTIMIZATION SYSTEM
1.5 REAL-TIME AVAILABILITY OF ANNOTATORS
1.6 CONSTRAINTS ON RESPONSE TIME
1.7 SEQUENTIAL AND COMPETITIVE RECOMMENDATIONS
1.8 RECOMMENDATION TO LABELING PARTNERS
1.9 LABELING QUALITY ASSURANCE
1.10 ADVERSARIAL ANNOTATIONS AND LABELING QUALITY ASSURANCE
1.11 CONSISTENT LABELING INSTRUCTIONS
1.12 EXPERIMENT-LEVEL VS. LOOP-LEVEL LABELING PARTNERS
1.13 SKIP-STEP/SKIP-LOOP ACTIVE LEARNING

2. EXAMPLE PROCESSING FLOWS
2.1 PROCESS WITHOUT DATA CURATION
2.2 PROCESS WITH DATA CURATION

3. IMPLEMENTATION EXAMPLE—HARDWARE OVERVIEW

4. EXTENSIONS AND ALTERNATIVES

In order to find a labeling provider capable of delivering on the expectations of the customer, there is a need for a solution able to efficiently compare the capabilities, availability, performance, and costs of various labeling providers. In an embodiment, the present disclosure provides a system comprising a computer-implemented labeling marketplace, through which a suitable labeling partner (i.e., labeling provider partnered with the computer-implemented labeling marketplace) will be automatically selected, based both on historical and real-time metrics, to handle the task requested by a customer. In another embodiment, the system may provide a short-list of labeling partners that are similarly determined to be suitable for handling the task. Such selection processes may involve eliminating from the selection pool labeling partners that are not capable of handling the requested task, determining real-time availability of the labeling partners, and evaluating the labeling partners' performance history, costs, and various other factors that may be relevant to delivering on the expectations of the customers. In an embodiment, the system may incorporate a quality control process, in which the tasks completed by the labeling partners may be evaluated.

1. Example Distributed Computer System Environment

1.1 Computer System Overview

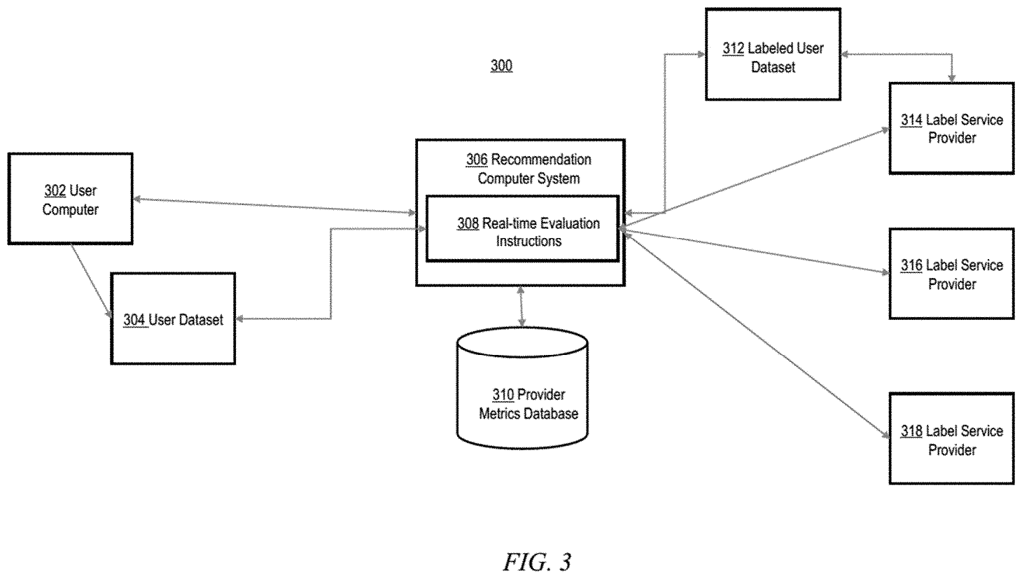

FIG. 3 illustrates an example network of distributed computers that can form one environment or context for an embodiment. For purposes of the appended claims, each element of FIG. 3 having a reference numeral represents a computer associated with an entity, rather than the entity itself. Thus, all elements of FIG. 3 are technical elements, and none represents a person or entity. Each computer may be any of a server computer, a virtual computing instance hosted in a public or private data center or cloud computing service, a mobile computing device, personal computer or other computer as appropriate to the associated entity and functional purpose.

In an embodiment, a distributed computer system comprises at least one user computer 302 that is communicatively coupled via one or more network links, represented as arrows, to a recommendation computer system 306 that is programmed with real-time evaluation instructions 308 and communicatively coupled to a provider metrics database 310. The recommendation computer system 306 is coupled via one or more network links, represented as arrows, to two or more label service providers 314, 316, 318.

In various embodiments, each of the user computer 302, recommendation computer system 306, and label service providers 314, 316, 318 comprise any of a server computer, a virtual computing instance hosted in a public or private data center or cloud computing service, a mobile computing device, personal computer, or other computer depending on the performance metrics that are desired in the system; such as throughput, response time, or storage capability. In various embodiments, each of the network links comprises one or more local area networks, wide area networks, or internetworks using any of wired or wireless, terrestrial or satellite links.

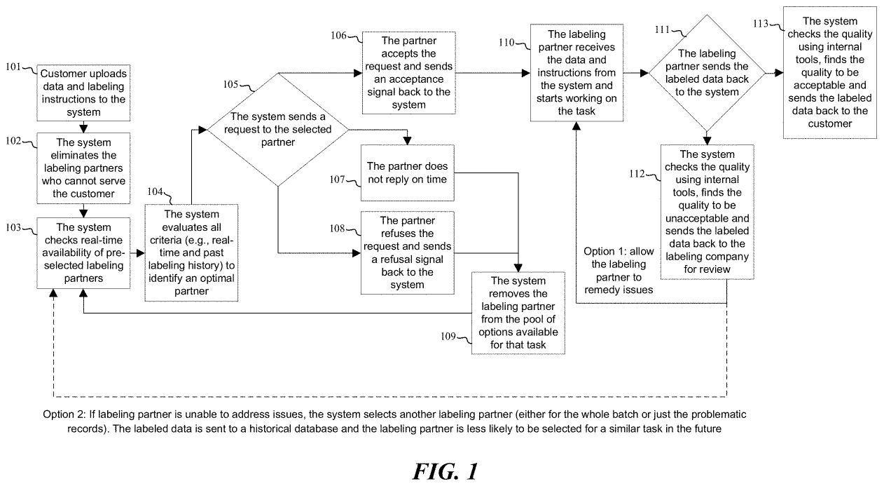

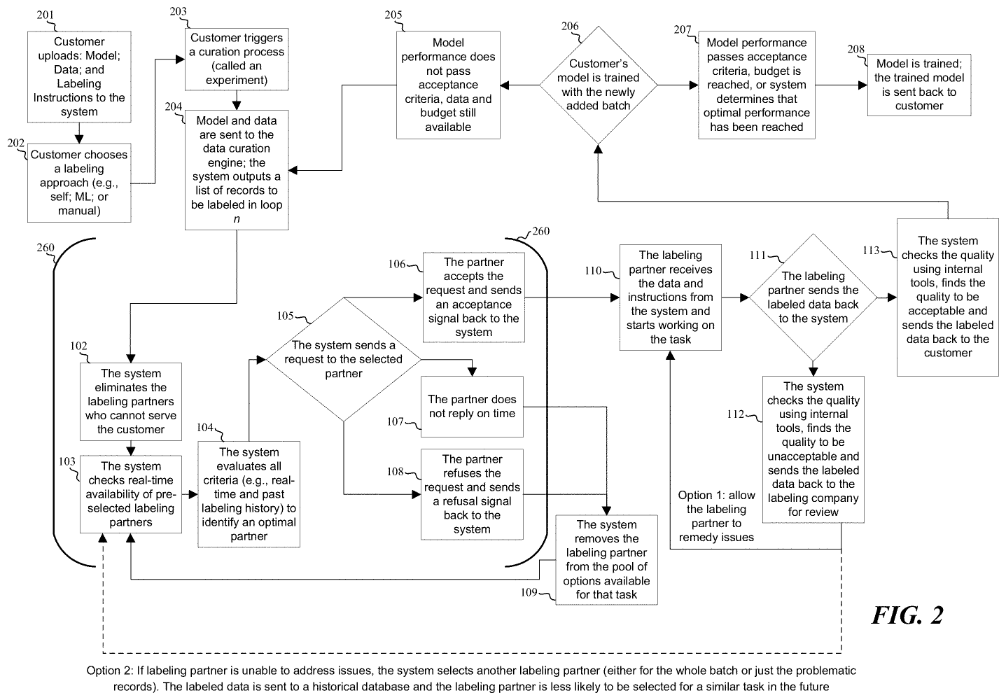

In an embodiment, the real-time evaluation instructions 308 are programmed to execute the functions that are further described herein with respect to FIG. 1, or FIG. 2, or both FIG. 1 and FIG. 2. The provider metrics database 310 is programmed with a data schema capable of storing a plurality of performance values or metrics for each of the label service providers 314, 316, 318.

Functionally, user computer 302 is programmed to transmit, to recommendation computer system 306, a user dataset 304 comprising two or more of a dataset to be labeled, instructions for labeling, and a machine learning model; recommendation computer system 306 is programmed using the real-time evaluation instructions 308 to query the provider metrics database 310 and to select, automatically and based upon programmed recommendation or evaluation algorithms, one or more of the label service providers 314, 316, 318 that is optimal to perform one or more labeling tasks on the user dataset; to transmit the user dataset to the selected label service provider; to receive a labeled user dataset 312 from the selected label service provider; to evaluate the performance of the label service provider and update the database; and to transmit the labeled user dataset to the user computer. The execution of the foregoing functions for specific embodiments is described further in other sections herein in relation to FIG. 1, FIG. 2.

1.2 Integration of Recommendation Processes with Other Systems

The system of this disclosure provides labeling services to customers by finding a labeling partner that is suitable to handle the tasks requested by the customers. A customer may rely on the system to automatically select the labeling partner that is most likely to provide the highest labeling quality in a timely manner, or alternatively, the system may provide the customer with a short-list of labeling partners determined to be suitable for handling the requested task.

In an embodiment, the system of this disclosure may integrate a data preparation system having data curation technology by employing an Active Learning approach. The Active Learning approach disclosed herein is a form of a semi-supervised, iterative machine learning approach of prioritizing portions of the data so the portions that are most effective in training the machine learning model are labeled first. In such an embodiment, the system may provide the customer's data to a labeling partner in small batches. When the labeling partner finishes labeling the first batch of data, the system may train a customer-provided model with the labeled data, then evaluate the model's performance. Machine learning models that customers provide can include linear classifiers, neural networks, or other ML models and the particular type of ML model is not critical. In an embodiment, the system of this disclosure is programmed to support any model provided by the customer through a programmatic interface such as a software development kit (SDK); the customer hosts both their model and their data, the SDK controlling two things:

1. The communication of the indexes of the records that have been selected for retaining, the selection of the indexes being made in the system of this disclosure, and the subsequent retraining being executed using the system;

2. The retrieval of training metadata (such as loss function, activation functions, parameter values and their derivatives, as a singular value or a time series)

Common use cases that customers may work on include: Image classification; Object detection (2D and 3D); Semantic segmentation (2D and 3D); Instance segmentation (2D and 3D); Pose detection; Facial recognition; Event detection (audio and video); Text classification (including but not limited to sentiment analysis and topic modeling); Content moderation (text, image, audio); Audio transcription; Machine translation; Anomaly detection; Regression. Types of models include: Deep learning models (all architectures), and these models can be pre-trained/off the shelf or custom-made by the user), including but not limited to CNN; RNN; LSTM; MLP; SOM; DBM; GAN; Classical ML models, such as (not limited to) Random forest; Logistic regression; XGBoost.

If the system determines that the model has been sufficiently trained, the trained model and the labeled data may be provided to the customer. If the system determines that the model has not been sufficiently trained, the process may be repeated by providing the labeling provider with the next batch of data along with all the previous batches of data. Additional details of this processes are discussed below.

In the current status of the data labeling market, it may be difficult for some of the smaller labeling providers (e.g., smaller in terms of the size of the labor force, or number of labelers or annotators) to compete with the larger labeling providers regardless of whether some of the smaller labeling providers are capable of providing a superior quality of work (e.g., labeling accuracy, turn-around time, etc.). Many of the labeling providers in the industry are highly specialized, particularly the smaller labeling providers, due to the fact that many labeling tasks require specialized knowledge in particular technologies or languages (e.g., computer vision, translation) or access to a specific kind of tools (e.g., software or hardware for Light Detection and Ranging, or LiDAR). Some of these specialized or smaller labeling providers are able to provide superior labeling accuracy and faster turn-around time for certain types of tasks than their larger counterparts because they employ annotators that are more capable, knowledgeable, and skilled in handling those types of tasks. However, in situations where a customer has various types of, or large volume, labeling needs, a single smaller labeling provider may not be capable of handling all of the customer's needs. Thus, the customer may be incentivized to work with a larger labeling provider capable of handling all of the customer's needs rather than a smaller labeling provider that cannot, even if the smaller provider is known in the industry as providing a higher quality of work for some of the customer's needs. The system of this disclosure provides a solution to these problems by allowing customers to rely on a computer-implemented labeling marketplace to find the labeling provider that is most likely to produce the highest labeling quality and in a timely-manner, regardless of the size of the labeling providers and for whatever types of labeling tasks.

1.3 Preliminary Task Filter

In an embodiment, the system of this disclosure may determine the minimum criteria required for handling the labeling tasks requested by the customers. This may involve determining the type of the customers' data (e.g., image, video, text, etc.) and the type of labeling task. This may involve the use of a platform accessed by the customer. For task filtering, customer, when creating a labeling task request, may be asked to provide the data type and task type. Every labeling task created in association to the customer's project may then automatically be recognized with the matching data type and task type. Labeling partners unable to perform the labeling task because of an inability to perform tasks with the data type and task type requested may be eliminated from consideration for the labeling task. Examples of the various types of tasks may include, but are not limited to, the following.

1) For Computer Vision (image-based data)
a) 2D image data
   i) Image classification (content, content moderation, subjective tasks like expression analysis, etc.)
   ii) Image classification with localization
   iii) Object detection, including:
      (1) bounding box annotations
      (2) polygons annotations
      (3) pots (joint detection for pose detection, landmark detection for facial recognition, etc.)
   iv) Object segmentation
   v) Instance segmentation
   vi) Image captioning
   vii)Object counting (extrapolation)
b) 3D image data (e.g., LIDAR, CTscan, etc.)
   i) Classification
   ii) Classification with localization
   iii) 3D object detection
   iv) 3D object segmentation
   v) 3D instance segmentation
c) Video data
   i) Classification
   ii) Object detection
   iii) Object or instance segmentation
   iv) Object tracking
   v) Event detection

2) For Natural Language Processing (text-based data)
a) Text classification, including:
   i) content moderation
   ii) topic modeling
   iii) sentiment
b) Entity extraction
c) Search relevance (by ranking or scoring)
d) Similarity matching
e) Text summarization
f) Question-Answering
g) Translation

3) For Audio Data
a) Classification
b) Transcription (speech-to-text)
c) Event detection

4) For Numerical Data
a) Medical diagnosis (e.g., diagnosis based on blood pressure, temperature, etc.)
b) Financial analysis (e.g., stock performances, etc.)

In an embodiment, the minimum criteria may be determined during one of the initial phases of the system's processes so any labeling partners that are not capable of handling the requested tasks could be eliminated from the selection pool.

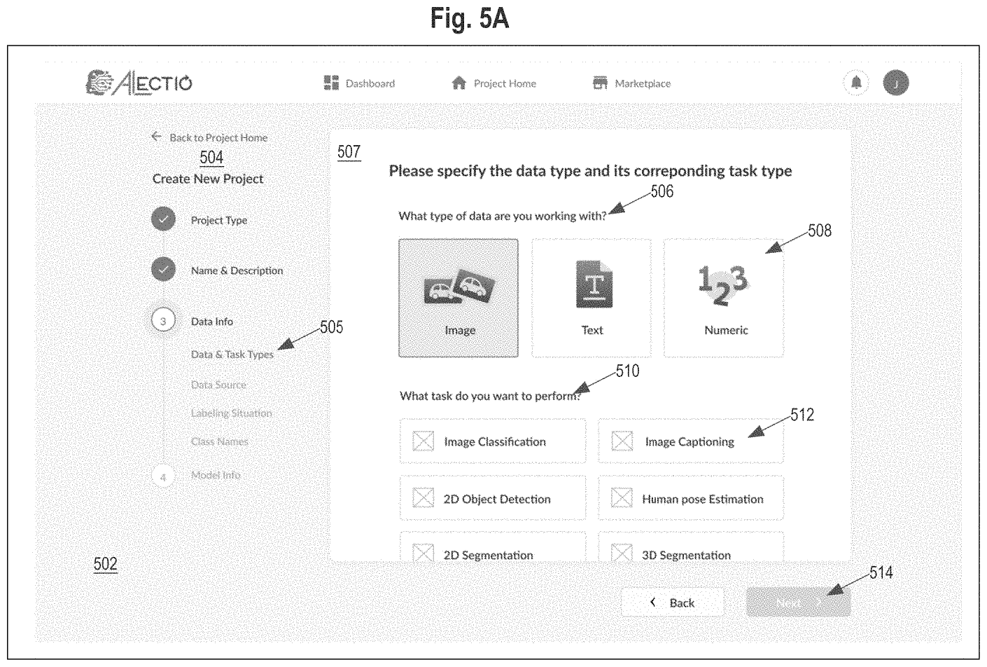

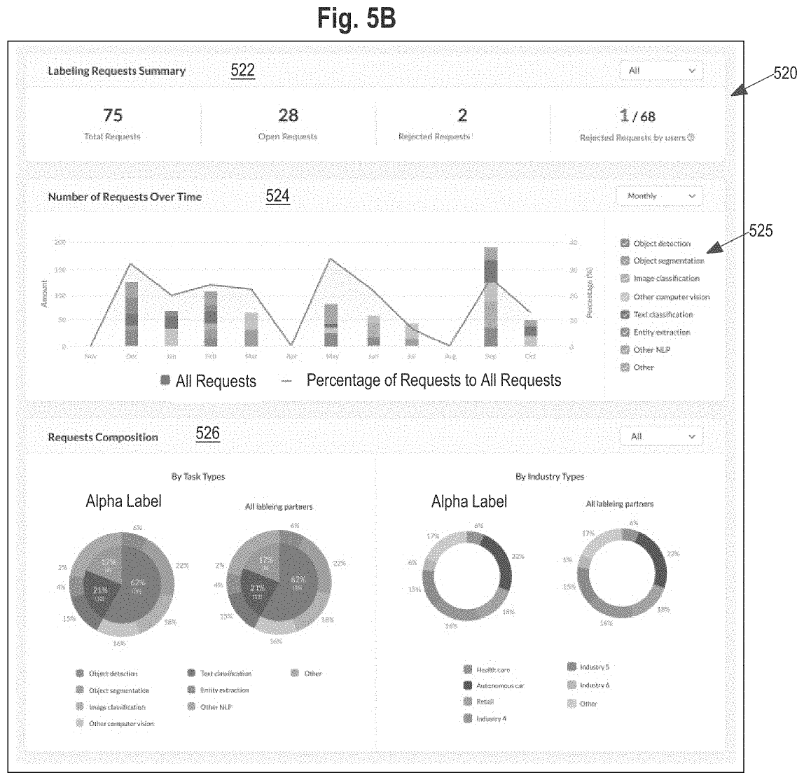

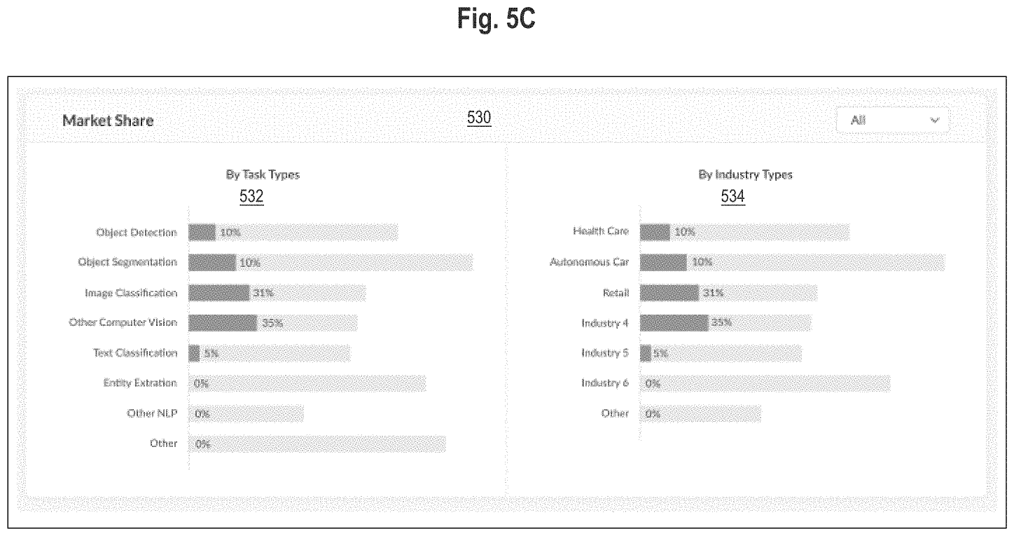

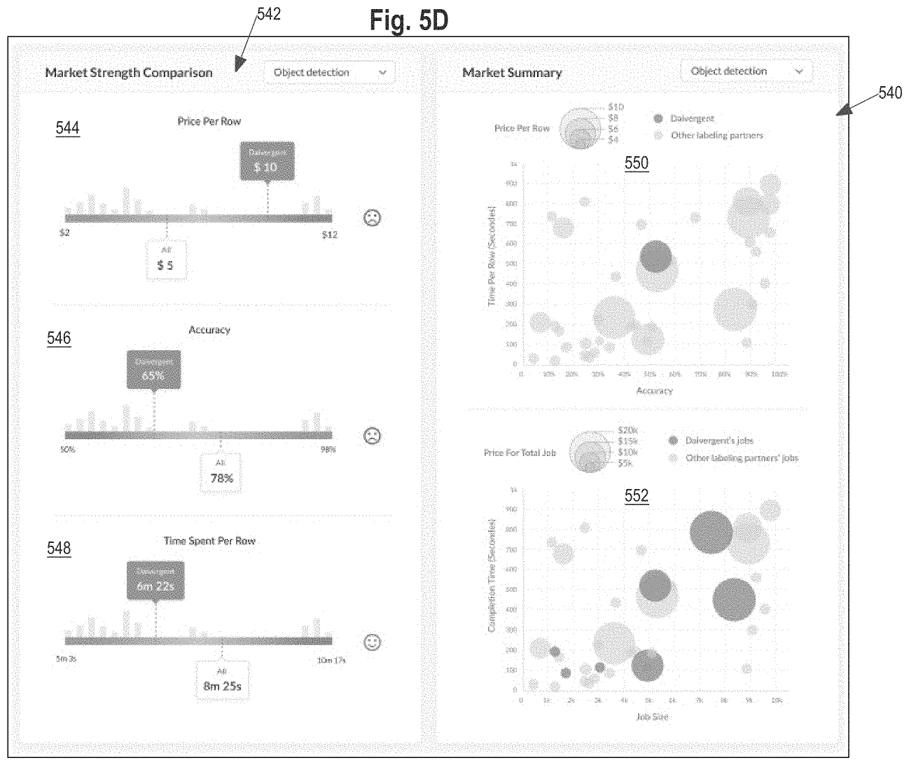

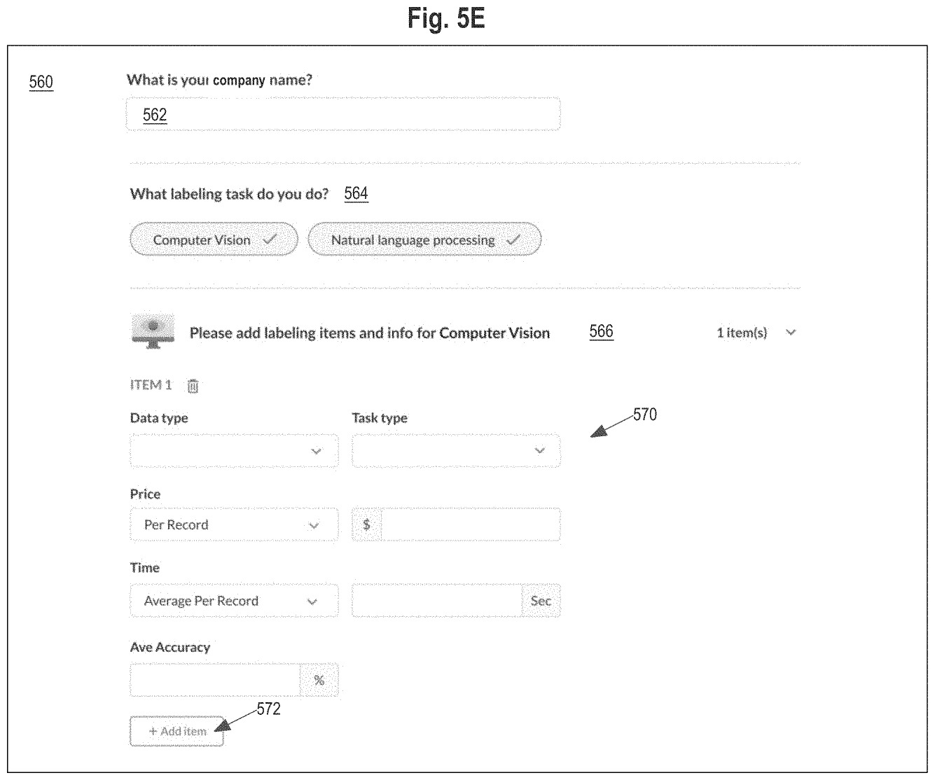

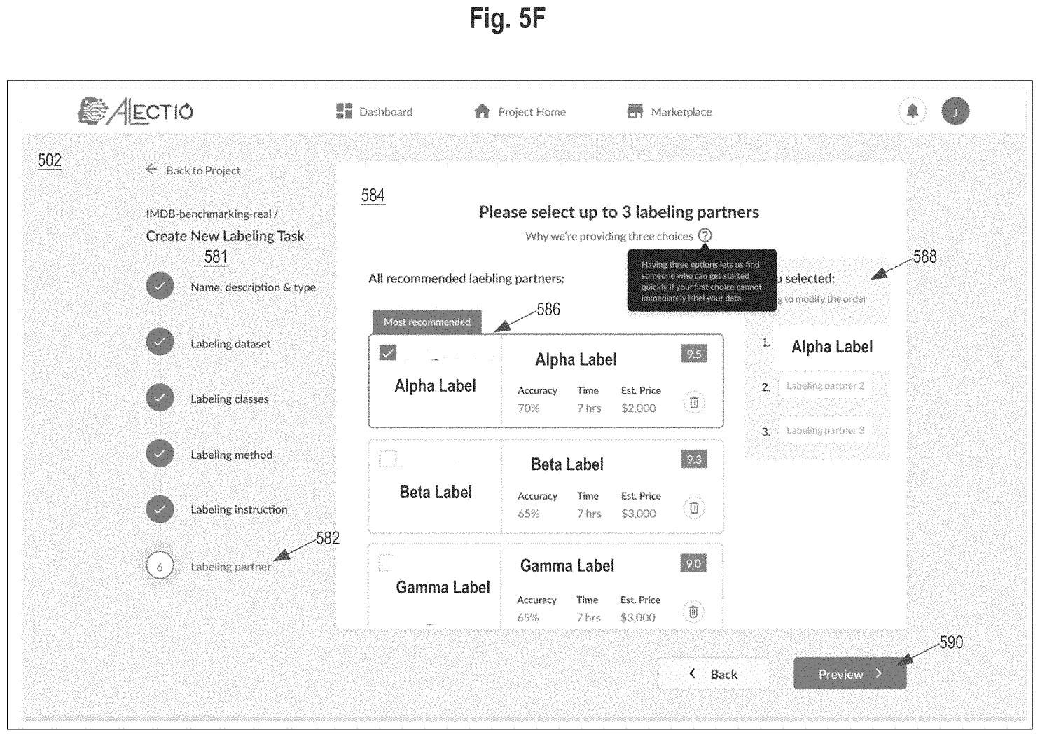

FIG. 5A illustrates a computer display device that is displaying an example of a graphical user interface with which a customer can provide information about its data labeling requirements to the computer system of an embodiment. In an embodiment, the system is programmed to cause generating and transmitting presentation instructions to a client device such as a client computer system executing a browser and which, when executed, cause the client device to display a project creation wizard window 502 via the browser. In an embodiment, the project creation wizard window 502 comprises a project workflow panel 504, which may comprise a plurality of active links, each of which when selected causes displaying a different set of text, image, and data entry widgets that can be used to complete a task for a project. In the example of FIG. 5A, a “Data & Task Types” link 505 has been selected and has caused displaying panel 507 having displays and widgets associated with specifying customer data and task types.

Panel 507 comprises a data type prompt 506 to which a client device can respond with input to select one of a plurality of data type icons 508, for example, specifying image data, text data, or numeric data. Input from the client device selecting a particular data type icon 508 causes forming and storing a value to identify the data type in a record associated with the customer of the client device. Panel 507 comprises a data task prompt 510 to which the client device can respond with input to select one of a plurality of task checkboxes 512 to specify a particular kind of data processing task that the customer needs. Panel 507 comprises a Next button 514 programmed with an active link which, when selected via input from the client device, causes submitting a response to the server computer that includes the selections that were made in the panel 507. The foregoing is an example of a GUI that can be programmed to obtain data from a customer, via a client computer, to specify data types and data tasks.

1.4 Collected Metadata and Optimization System

In an embodiment, the system collects various information of the labeling partners, which may be used by the optimization system to find the most suitable labeling partner for a customer-requested task. The information may be collected by granting the labeling partners access to a dedicated analytical dashboard (i.e., a user interface) where the labeling partners may enter and control certain information, including but not limited to their parameters and pricing. The labeling partners may also use the analytical dashboard to review how competitive they are on the market. Examples of such information that the system collects of the labeling partners may include, but is not limited to, the following.

1) Static data (maintained from time to time by labeling partners)
a) List of the types of tasks that the partner can deliver on (depends on tooling and labor workforce)
b) Available clearance
c) Annotator information
   i) List of annotators
   ii) Location of annotator (e.g., time zone)
   iii) Type of tasks annotators are capable of working on
   iv) Type of tasks annotators prefer to work on (e.g., ranked)
   v) Historical performance of the annotators (e.g., speed and accuracy)
   vi) Desired workload of annotators

2) Dynamic data
a) Real-time availability of annotators (e.g., through an API)

In an embodiment, the system may compute and maintain various metrics of the labeling providers. Examples of such metrics may include, but are not limited to, the following.

1) Partner-level metrics
a) Average labeling quality (e.g., accuracy) for various types of tasks
b) Average labeling speed for various types of tasks
c) Typical availability
d) Average price, and deviation from standard price
e) Time since last offered task
f) Time of idle (e.g., no assigned task)
g) Time taken to resolve labeling issues identified by the quality control process; and number of iterations required to solve a labeling issue
h) Response time to the system's inquiry/notifications
i) Acceptance/rejection/ignore statistics of labeling tasks

2) Annotator-level metrics
a) Average labeling quality (e.g., accuracy) for various types of tasks
b) Average labeling speed for various types of tasks
c) Typical availability
d) Time since last offered task
e) Time of idle (e.g., no assigned task)
f) Response time to the system's inquiry/notifications
g) Acceptance/rejection/ignore statistics of labeling tasks

In an embodiment, the system may utilize a multi-objective optimization process to find a labeling partner that is most likely to produce the highest quality of work. Examples of the factors considered during the optimization process include, but are not limited to, the following.
1) Turn-around time (e.g., on average how long does the labeling partner need to complete and return a task.)
2) Labeling quality (e.g., how accurate is the labeled data)
3) Average cost (e.g., the average cost charged by the labeling partner for various types of tasks)
4) Revenue (e.g., how much did the labeling partner earn for a given period of time)
5) Number of, and type of, tasks previously offered to the labeling partner
6) Number of labeling partners within the computer-implemented labeling marketplace
7) Customer's preferences/criteria

In an embodiment, the optimization process may be programmed using any of: the Dantzig simplex algorithm, extensions or variants thereof; combinatorial algorithms; or quantum optimization algorithms.

FIG. 5B illustrates a computer display device that is displaying an example of a graphical user interface providing an analytical dashboard to report performance statistics and metrics for a labeling partner. FIG. 5C illustrates a computer display device that is displaying an example of a graphical user interface providing bar graphs of market share of labeling partners and which may form a portion of a larger interface that includes FIG. 5B, FIG. 5D. FIG. 5D illustrates a computer display device that is displaying an example of a graphical user interface providing machine-generated graphical diagrams of statistical data relating to a labeling partner and which may form a portion of a larger interface that includes FIG. 5B, FIG. 5C. Referring first to FIG. 5B, in an embodiment, the system is programmed to generate presentation instructions which when rendered using a client device cause displaying an analytics dashboard 520 in graphical form on the display device of the client device. In an embodiment, the system is programmed to generate and display the following graphical elements, based upon performance data and metrics that have been received from labeling partners as the labeling partners have executed data labeling projects:

Labeling requests summary panel 522—A panel in the analytics dashboard that visually shows basic numeric metrics such as total requests received by the labeling partner, number of labeling requests that the labeling partner has not yet completed (“open requests”), number of requests that the labeling partner has rejected, and number of requests that users of the platform have rejected after the labeling partner was assigned to a user project.

Number of requests over time panel 524 — A panel comprising a visualization of the number of requests that a particular labeling partner has processed over time, including in relation to all requests processed in the system for all labeling partners. The visualization may comprise a bar chart having a plurality of bars, each bar being associated with a calendar month or other period. Each bar may be displayed using different colors or other distinctive representations, such as hatching or shading, that are associated with a legend 525 identifying different data labeling subjects or tasks that were associated with past requests.

Requests composition panel 526 — A panel comprising one or more visualizations of the substantive tasks involved in prior requests that the particular labeling partner handled and that all labeling partners in the marketplace handled. The visualizations may comprise pie charts, circle charts, or other representations of portions of different kinds of requests, with wedges, arc segments, or other units of the visualizations being keyed to legends that specify task types. Visualizations may be associated with industry types, task types, or other attributes of requests or customers.

Referring now to FIG. 5C, in an embodiment, the system is programmed to generate and display the following graphical elements, based upon performance data and metrics that have been received from labeling partners as the labeling partners have executed data labeling projects, in the same analytical dashboard as shown in FIG. 5B. Thus, in an embodiment, FIG. 5C represents a further portion of the display of FIG. 5B that might be accessed, for example, by scrolling a browser window of the client device.

Market share panel 530—A panel comprising one or more visualizations of proportional market share of requests handled by the particular labeling partner, organized by task types, industry types, or other attributes of past requests. For example, a task type bar graph 532 may comprise a plurality of graphical bars, each bar being generated based on data for past requests having attributes of a particular task type. Or, an industry type bar graph 534 may comprise a plurality of graphical bars, each bar being generated based on data for past requests having a particular industry type identified in and/or stored in association with the request.

FIG. 5E illustrates a computer display device that is displaying an example of a graphical user interface with which a labeling partner can provide information about its data labeling capabilities to the computer system of an embodiment. In an embodiment, the system is programmed to generate presentation instructions which when rendered using a client device cause displaying a labeling partner data entry form 560 in graphical form on the display device of the client device. In an embodiment, the system is programmed to generate and display the following form elements and/or widgets, each of which is programmed to prompt for and/or receive input specifying data about a labeling partner:

Company name field 562—A text entry field programmed to receive an entry of a name of a labeling partner.

Labeling task list 564—A filter field programmed to receive selections of a plurality of different possible labeling tasks.

Task detail panel 566—One of a plurality of visual panels, each being associated with one of the different labeling tasks that were specified via labeling task list 564, and programmed to receive in a plurality of data entry widgets 570: a data type, task type, price per record or other unit, average time to perform the task per record or other unit, average accuracy.

Add item button 572—A link, button, or other active widget that is programmed, when selected, to add another labeling task to task list 564, and to concurrently cause displaying another task panel 566 that corresponds to the new labeling tasks, to receive data for that task.

In this manner, a labeling partner can describe any number of data labeling capabilities and report basic pricing and performance data for consideration in recommendations to customers using the algorithms that are further described in other sections herein.

1.5 Real-Time Availability of Annotators

In an embodiment, the system of this disclosure may identify a labeling partner that is most suitable for handling the customer's task by considering, among others, real-time availability of the annotators employed by the various labeling partners. The system may require the labeling partners to provide a method of tracking real-time availability of each of their annotators. For example, the system may require the labeling partners to support an API that allows the system to track each of their annotator's computer activity, or to provide some other indicators to verify whether the annotators are available to receive a labeling task. The labeling partners may also be required to provide information regarding the location (e.g., time zone) associated with each of the annotators or notifications of any known issues that may render the annotators unavailable (e.g., power or internet access shutdown in the location of the annotator).

1.6 Constraints on Response Time

In an embodiment, to provide customers with consistent and efficient turn-around time for the delivery of the requested tasks, the system of this disclosure may place certain time constraints on the labeling partners. Customers may choose their prioritization criteria, including placing certain time constraints on the labeling partners, using the customer platform. For example, once a suitable labeling partner is selected and offered the labeling task, the system may require the labeling partner to respond to the offer within a limited time period (e.g., 10 minutes). If the labeling partner accepts the task, the system may require the labeling partner to start the task within a limited time period thereafter (e.g., 15 minutes). In such a case, the system may require the labeling partner to provide a notification specifying that the task has been started. The system may provide the labeling partner a limited amount of time to complete any task accepted by the labeling partner, which time period may be determined based on the historical data of the labeling partner or other labeling partners (e.g., average amount of time needed to complete a task of a similar type). Once the task has been completed, the system may require the labeling partner to return the completed task within a limited amount of time (e.g., 15 minutes). In such a case, the system may require the labeling partner to provide a notification specifying that the task has been completed, or alternatively, the system may determine that the task has been completed by tracking the labeling partner's annotators.

In an embodiment, the customer may be shown a ranked list of labeling partners and be requested to select its top three choices. The first selected labeling partner may be offered the labeling task. If the first selected labeling partner fails to respond in time, the system of this disclosure may automatically route the request to the labeling partner that was the customer's second top choice. If all three of the customer's initial selections decline the request or fail to timely respond, the system of this disclosure may notify the customer of this failed status and may prompt the customer to continue to select additional labeling partners or to make adjustments to its labeling methodology until a suitable labeling partner accepts the offer for the labeling task. The system of this disclosure may employ any one or combination of the time constraints described above.

FIG. 5F illustrates a computer display device that is displaying an example of a graphical user interface with which a customer can select one or more labeling partners and view recommendations of labeling partners. In an embodiment, the display example of FIG. 5F is generated within the project creation wizard window 502 (FIG. 5A) and can be viewed as logically following the project workflow panel 504, to display a new labeling task workflow panel 581 in place of the project workflow panel. In the example of FIG. 5F, a client device has selected a “Labeling partner” link 582 to signal the server computer to recommend one or more specific labeling partners.

In response, the system is programmed to generate and transmit presentation instructions to render a selection panel 584, which specifies a plurality of different available labeling partners, denoted Alpha Label, Beta Label, Gamma Label for example purposes. In an embodiment, three (3) choices are provided and a top recommendation appears first in order with partner-specific data displayed in a partner detail tile 586. Thus, data such as historical accuracy, time to completion, and pricing for the particular label partner “Alpha Label” appears in tile 586, and two or more other tiles may be displayed in a scrollable list of tiles below the tile 586. In an embodiment, input from the client device to select a checkbox near the name of the labeling partner in a tile such as tile 586 indicates the selection of that labeling partner. A reordering widget 588 may be provided by which the client device can change an order of the tiles to view other labeling partners in more detail. In an embodiment, panel 502 comprises a Preview widget 590 which, when selected, causes executing a preview of the execution of the data labeling task with the selected labeling partner.

In an embodiment, the system of this disclosure may integrate a data preparation system having data curation technology by employing an Active Learning approach. A data labeling process integrating a data preparation and data curation processes is called an “experiment” and is often executed in iterations, or “loops.” As discussed above, Active Learning is a form of a semi-supervised, iterative machine learning approach of prioritizing portions of the data so the portions that are most effective in training the machine learning model are labeled first. In such an embodiment, the system may begin the experiment by providing a first batch of data (identified by the data curation engine) to the labeling provider. Once the first batch of data is labeled, the system may train the customer's model with the labeled data. Then, the system may evaluate the model's performance and determine whether to end the experiment or execute an additional loop. For example, if a customer provides a data set comprising 100,000 images, the system may initially instruct a labeling partner selected for the task to label 1,000 images identified by the data curation engine. Once the first 1,000 images are labeled by the labeling partner, the system trains the model using the labeled images. At this point, the first loop ends, and the system determines whether an additional loop should be executed by evaluating the model's performance. If the system determines that the model's performance is not acceptable, another loop is executed by instructing the labeling partner to label 1,000 additional images identified by the data curation engine along with all the previously labeled images (e.g., 2,000 total images in the second loop, 3,000 total images in the third loop, etc.). If the system determines that the model's performance is acceptable, the experiment ends, and the customer is provided with the labeled data and trained model. Alternatively, the system may end the experiment if it determines that the model has reached its optimal performance. The system determines that the model has reached its optimal performance if the portions of the data identified by the data curation engine as being effective at training the model have all been labeled and only the portions that are identified as redundant or irrelevant in training the model are left. In an embodiment, the system may also end the experiment if the customer's budget has run out.

1.7 Sequential and Competitive Recommendations

In an embodiment, the system of this disclosure may select a labeling partner that is suitable for the customer's requested task in a sequential manner, such that the task is offered to only one labeling partner at a time. This mitigates a problem common in markets employing reverse-auction style bidding systems with which providers within those markets compete to offer jobs, or tasks, at lower prices, sometimes at the cost of reduced quality or performance, thus resulting in a “race to the bottom”. Here, the system may offer tasks to its labeling partners in a sequential manner to mitigate such problems. If the task is rejected or the selected labeling partner does not respond within the required time limit, the task may be offered to another labeling partner. In such a case, the system may offer the task to another labeling partner that was previously determined as the second most suitable for the task. Alternatively, the system may re-evaluate all of the labeling partners within the selection pool, for example, in situations where enough time has passed, and real-time metrics associated with the labeling partners have substantially changed.

In an embodiment, the system of this disclosure may select a labeling partner that is suitable for the customer's requested task by employing a self-serve process, bidding process, or reverse-bidding process. If, for example, a customer prioritizes cost as an important criteria for the task, the task may be offered to several labeling partners at the same time. In such a case, the labeling partner that provides the lowest cost for the task may be selected. Alternatively, the system may provide to the customer a list of labeling providers determined to be suitable for the task, along with the costs associated with each of the providers.

With the self-serve process, the user creates a labeling task on the system, by adding info such as: The amount of data that needs to be labeled (that info can be generated by the data curation engine in the case of a dynamic labeling task); The type of data (text, image, video, audio, . . . ); The task type (object detection, classification, regression, segmentation, . . . ); The budget ($); Their timeline; Their quality (labeling accuracy) requirements. Suitable labeling partners can then accept the task if they are happy with the conditions.

With the bidding process, the user creates a labeling task on the system, by adding info such as: The amount of data that needs to be labeled (that info can be generated by the data curation engine in the case of a dynamic labeling task); The type of data (text, image, video, audio, . . . ); The task type (object detection, classification, regression, segmentation, . . . ). Suitable labeling partners can then make an offer to perform the task by sending a proposal with their expectations from a money, time and accuracy perspective (We could take care of your job in 30 min for $800 and guarantee a 98% accuracy).

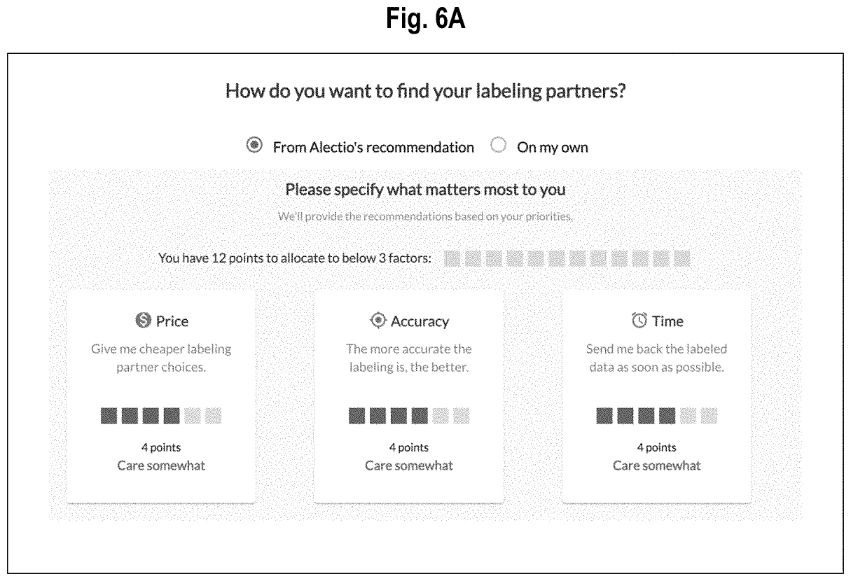

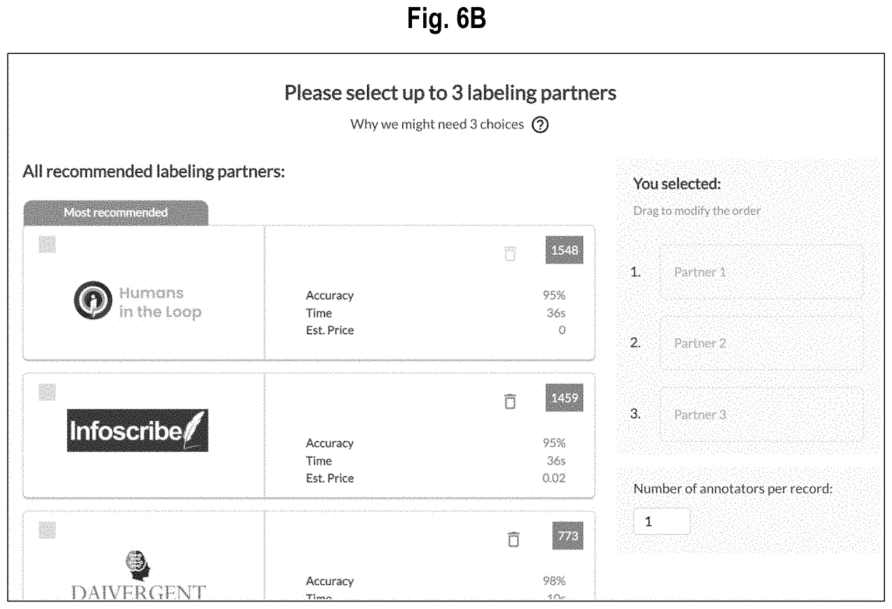

With the reverse-bidding process, the user creates a labeling task on the system, by adding info such as: The amount of data that needs to be labeled (that info can be generated by the data curation engine in the case of a dynamic labeling task); The type of data (text, image, video, audio, . . . ); The task type (object detection, classification, regression, segmentation, . . . ); Relative importance of price, time and accuracy (done through a point allocation system using a front-end interface; the user will allocate 12 points across 3 priorities). FIG. 6A illustrates an example of a graphical user interface with input widgets that can be programmed to implement a point allocation system. Real-time evaluation instructions 308 (FIG. 3) can be programmed to generate presentation instructions for all front-end functions and graphical user interfaces described herein, including in the drawing figures, for presentation at user computer 302.

In an embodiment, the system disclosed herein (which has historical data for price, time and accuracy from previous jobs, on a use case-by-use case basis), is programmed to compute the z-score of each valid labeling partner for price, time and accuracy. Each of the z-scores is weighted with the number of points allocated to the feature (for price and time, a −1 factor is added, since lower price or time is better). The system is programmed to compute the sum and to return a ranked list of recommendations based on the sum values. FIG. 6B illustrates an example of a graphical user interface that can be programmed as presentation output of an ordered set of recommended labeling partners.

1.8 Recommendation to Labeling Partners

In an embodiment, the system of this disclosure may provide various feedback to the labeling partners. This feedback may be provided on the analytical dashboard (i.e., user interface). For example, the system may provide task-level feedback that provides information about why a specific task was not offered to a labeling partner (e.g., insufficient availability of annotators, lack of tooling, etc.) or aggregated feedback that provides information about why specific types of tasks, or tasks in general, are not offered to the labeling partner (e.g., statistical insights about subpar turn-around time or labeling accuracy). The system may also make available to the labeling partners data showing where they rank compared to their competitors based on factors, including but not limited to, pricing, performance, and labeling accuracy. For example, the system may notify the labeling partners of their labeling accuracy on a project and disclose their percentile rank as compared to their competitors completing similar types of projects.

In an embodiment, the system of this disclosure may provide labeling partners with access to analytical dashboards that provides statistical data on various metrics associated with the labeling tasks (e.g., price, labeling accuracy, turn-around time, etc.).

1.9 Labeling Quality Assurance

In an embodiment, the system of this disclosure may verify the quality of the labeling tasks completed by the labeling partners by evaluating the completed tasks. For example, if a labeling partner claims that the labeled data has achieved 90% labeling accuracy, the system may evaluate the completed task to validate the claim. Checking the validity of the results as returned by the labeling partner is highly dependent on the type of data and the task type in question. In an embodiment, recommendation computer system 306 can be programmed with a labeling quality management system comprising the combination of several solutions. The recommendation computer system 306 can be programmed with an anomaly detection engine that creates a distribution of the annotations as returned by the labeling partner and looks for potential anomalous annotations such as out of range values. The anomaly detection engine can be programmed for generating a z-score distribution in various features of interest. In the context of object detection, features of interest can include: Total number of objects in the same record; Number of objects of each class in the same record; Number of different classes that are represented in the same record; Length of the objects; Height of the objects; Depth of the objects (for 3D); Position (in X, Y, Z) of the objects; Aspect ratios of the objects. In the context of Named Entity Recognition, features of interest can include: Number of entities of same type in sample; “Distance” between entities of same type within sample; Position of entities in sample; Number of words (length) of entity in sample.

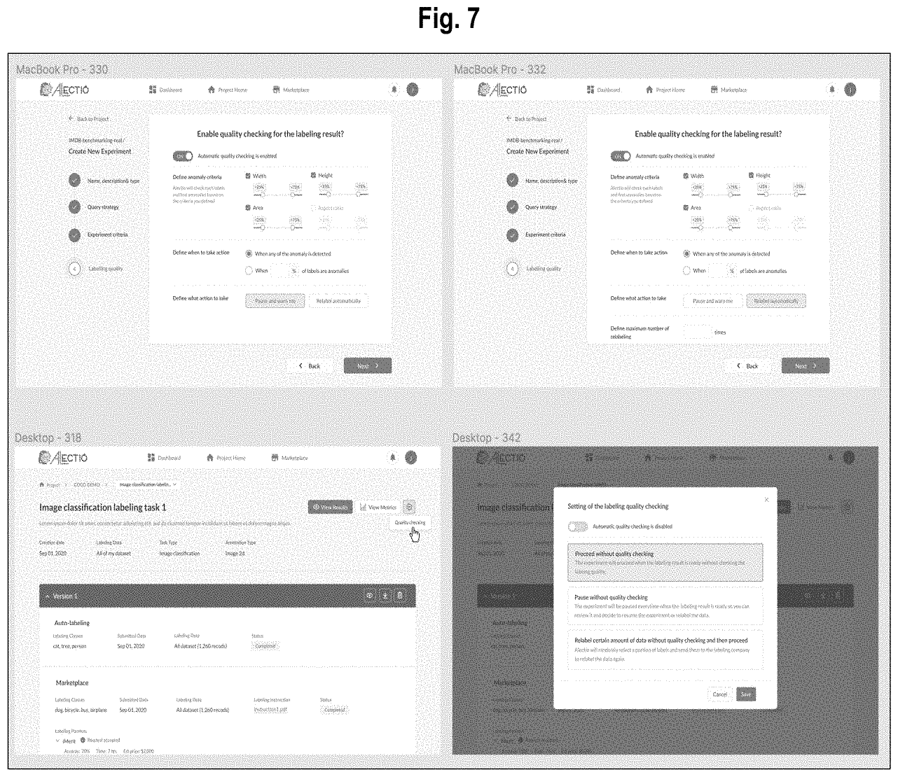

Additionally or alternatively, recommendation computer system 306 can be programmed with an autolabeling/pre-labeling process, using a pre-trained machine learning model to generate synthetic generation, which are checked against the manual annotations provided by the labeling partner. Examples can include: Open source libraries (such as NLTK Vader for sentiment analysis); Pre-training models (such as YoLo for object detection); or a pre-existing model that the user uploads to the recommendation computer system 306. FIG. 7 is a screenshot of how users control how validation/QA is done for their data.

In an embodiment, the recommendation computer system 306 can be programmed with any of several systems to select data for a user. In ML-driven data curation, which is active learning-based; data is selected dynamically during a training process. The user sets of an SDK which orchestrates an incremental training process remotely, with no need to export anything. The user model is first trained with a small sample and the SDK captures clues about the training process. That information is sent back to the recommendation computer system 306 or computer system 400 which analyzes what data to add next. The training process ends when the user reaches their budget or the remaining data contains no new relevant information.

In another embodiment, data filtering predicts which data should be useful prior to training. A pre-training data filter can eliminate useless data from databases or directly on the edge. The user sets up the SDK on their system and lets the SDK orchestrate a series of short training experiments. The system generates a data filter, which is a predictive model that scores records based on their value to the user model. The user downloads the data filter to their system and uses the data filter to filter new training data prior to training or retraining their model. The user also can deploy the filter on the edge of an internet of things (IoT) device to decide in real-time which records to keep.

Embodiments can implement the following user experience for the marketplace.

Hybrid Labeling Marketplace: Find awesome labeling partners that are available immediately. Process flow:

1. Tell us about your project, expectations, and time and budgetary constraints.

2. Choose between the recommended autolabeling and manual labeling options. Mix-and-Match.

3. You get a precise estimate of the cost, time and accuracy. Once the task launches, your data is immediately being labeled.

4. Use the human-in-the-loop module to find mislabeled data and send it for revision either to the same partner or a different partner.

Human-in-the-loop module: Visualize, audit, and fix your labels and measure labeling quality reliably.

1. Upload your existing labels or select a labeling task after the labels are sent back by your labeling partner.

2. View label anomalies or query data using your own validation criteria. No need to ever review an entire dataset anymore.

3. Fix faulty labels yourself with an annotation tool or send them back to either the same or a different labeling partner.

4. As you perfect your labels, they are automatically versioned, so that you can revert to an older version if needed.

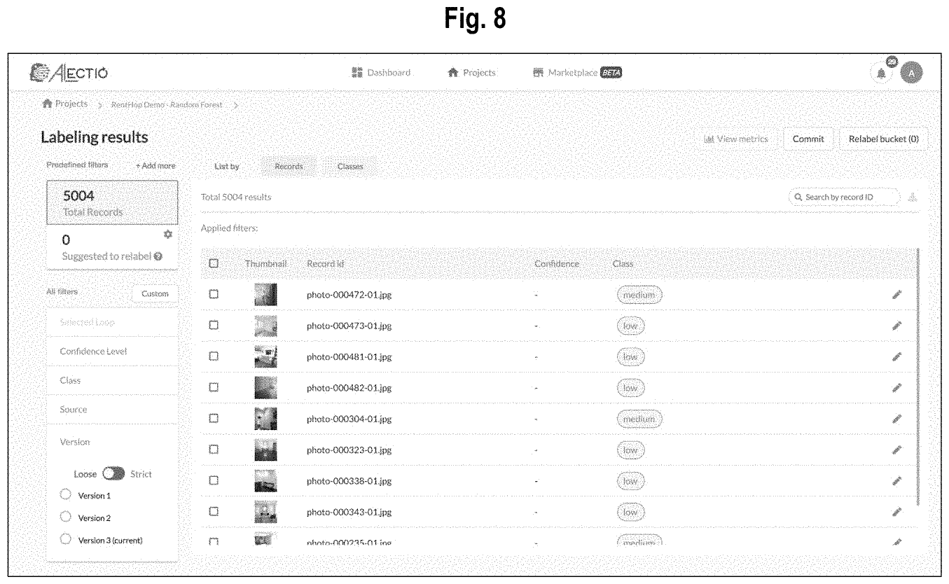

FIG. 8 illustrates an example graphical user interface output screen display of a Human-in-the-Loop module. In an embodiment, the user can interact with the display of FIG. 8 to validate quality manually, helped by the suggestions on the left “Suggested to relabel”. If they click a checkbox, this populates the “Relabel bucket” on the top right corner, and that data is rerouted to the labeling partner that they choose.

1.10 Adversarial Annotations and Labeling Quality Assurance

In an embodiment, the system of this disclosure may provide quality assurances by identifying problematic labels. In such an embodiment, the system may employ an adversarial process that involves providing deceptive or faulty data and evaluating the response of a service provider to receiving the deceptive or faulty data.

In an embodiment, the system of this disclosure may provide the data labeled by one labeling partner to another labeling partner for cross-validation.

1.11 Consistent Labeling Instructions

Labeling instructions are customer-provided instructions that define the scope of the labeling task. Labeling instructions are intended for annotators and provide guidance to how the data should be labeled, for example, by providing examples of correctly and incorrectly labeled data, covering edges cases and how they should be handled, describing best practices, and providing any other information that may be relevant for the labeling task. Labeling instructions are typically tailored based on the input from both the customer and the labeling partner by weighing the customer's expectations with the capabilities of the labeling partner. However, in the context of the system of this disclosure, it may be difficult to tailor the labeling instructions in such a way since a labeling partner may be automatically assigned to a task without an opportunity to obtain the labeling partner's input. Thus, in an embodiment, the system of this disclosure provides universal labeling instructions that are optimized for all labeling partners within the computer-implemented labeling marketplace. The universal labeling instructions are designed to be universally compatible with all of the labeling partners within the computer-implemented labeling marketplace by considering each of the labeling partners' capabilities at both the provider-level and annotator-level and the tooling available to the partners. The universal labeling instructions may also be designed to be task-specific, such that customers with certain types of labeling tasks are provided with universal labeling instructions customized for that task. The universal labeling instructions may include a required section and an optional section. For example, the universal labeling instructions may require a customer to provide three examples of correctly labeled data and one example of incorrectly labeled data and provide the option to provide additional examples.

1.12 Experiment-Level vs. Loop-Level Labeling Partners

In an embodiment, the system of this disclosure may select a labeling partner to handle the labeling at an experiment-level (i.e., the task in its entirety), which may involve one or more loops of labeling. This will provide consistency in the labeled data and minimize the inefficiencies that come from transitioning the task between several labeling partners.

In an embodiment, the system of this disclosure may select several labeling partners to handle the task, each labeling partner being assigned to a particular loop of the task. For example, if the system determines that a task can be partitioned into several loops and some of the loops are better suitable for one labeling partner while other loops are better suitable for another labeling partner, the system may assign the task to both labeling partners. For another example, if the system determines that a labeling task includes an amount of data that is too large for any one of the labeling partners in the selection pool, the system may assign various portions of the task to multiple labeling partners. The system may also assign a labeling task to several labeling partners if it determines that diversity among annotators may produce higher labeling quality.

1.13 Skip-Step/Skip-Loop Active Learning

With an experiment employing an Active Learning approach, data is typically labeled sequentially in small batches, or in loops. This means that, for example, until a labeling partner finishes labeling a batch of data, the system cannot train the model, and the data curation engine cannot curate the data for the next loop. Thus, a delay in any part of the experiment not only delays one part of the process but also all the downstream processes. The problem gets even worse if multiple labeling partners are in charge of the various processes of the experiment due to the inefficiencies that come from transitioning the task between several labeling partners. This problem makes the Active Learning approach impractical to some customers since they may not have the capability to wait for days or weeks for their task to be completed. The system of this disclosure provides several approaches to address this problem.

In an embodiment, the system of this disclosure may use a brute-force approach where it selects a batch of data equivalent to two loops, so after the first half of the batch is labeled in the first loop, the next half can be labeled in the second loop while the first half of the labeled data can be used to train the model.

In an embodiment, the system of this disclosure may use a Skip-Loop Active Learning approach. With Skip-Loop Active Learning, the system is programmed to predict not only the next batch of data to be labeled, but also which record should be labeled at a specific point in time or loop in the future. As an example, the system may be programmed to compute the records for loop n, but also n+1, n+2, and an arbitrary number of other loops. The further in time the prediction extends, the less confident the prediction will be. However, the system may be programmed to combine all past predictions, which are weighted differently to predict a few loops ahead.

In an embodiment, the system of this disclosure may use a Ranking-based Active Learning approach. With Ranking-based Active Learning, the system is programmed to re-rank data. In an embodiment, rather than predicting which record should be labeled in the context of a specific loop, the system is programmed to continuously re-rank records in the dataset based on qualitative aspects of the records (e.g., how effective the dataset is in training the model), which allows the system to select data not only for loop n, but the subsequent ones most effective in training the model as well.

2. Example Processing Flows

2.1 Process without Data Curation

FIG. 1 is a flowchart that illustrates the system's processes for labeling a customer's data, which includes the selection process for selecting a suitable labeling partner for the task based on an optimization system and the quality control process for verifying the data labeled by the selected labeling partner. The process illustrated in FIG. 1 does not integrate a data preparation system (i.e., no Active Learning), thus the data provided to the labeling partner may be provided in entirety (i.e., not in small batches).

In an embodiment, at step 101, a customer desiring a labeling service uploads the data and labeling instructions to the system. Based on the uploaded information, the system determines the type of data provided by the customer (e.g., image, video, text, etc.) and the type of the requested task (e.g., object detection, classification, object segmentation, etc.). Once the types of data and task are determined, the system determines the minimum criteria necessary to handle the task requested by the customer, which may include having access to particular tooling (e.g., hardware or software), being capable of understanding certain languages, having certain security clearance, or having a sufficient number of available annotators for the task. A programmed process to determine the minimum criteria can execute as follows. To provide labeling services to a customer, the labeling partner needs to fulfill the following expectations: Possess a task force capable/trained to manage the particular type of task (for example, if the customer is building a Japanese→French translator, the labeling partner needs annotators capable of translating Japanese to French); Possess the proper annotation tool for the said task (in the huge majority of the cases where the labeling partner does not possess the tool, Alectio will provide it to them through the labeling partner portal, a separate cloud-based tool dedicated to partners' management of customers' jobs); Be compliant to the level required by the user (for example, healthcare company might require the partner to be HIPAA compliant); Have at least one annotator available immediately (which Alectio checks by sending a signal via API to all valid labeling partners that pass the previous criteria). In an embodiment, provider metrics database 310 (FIG. 3) is programmed with a table schema containing values concerning the task force, annotation tool, and compliance capabilities of each labeling partner, which the partner provides at the time of enrollment or subscription, and maintains over time through the labeling partner portal. Recommendation computer system 306 is programmed to use provider metrics database 310 to retrieve a list of valid candidate partners after taking the input of the user from the frontend.

At step 102, the system applies the minimum criteria to each of the pre-selected labeling partners within the selection pool and eliminates any labeling partners that do not meet the minimum criteria, i.e., that are not capable of handling the task.

In an embodiment, at steps 103 and 104, the system applies an optimization process that evaluates real-time and historical metrics of all the labeling partners remaining in the selection pool. In particular, at step 103, the system checks the real-time availability of the labeling partners, which may include checking real-time availability of the annotators employed by each of the labeling partners (e.g., via an API). At step 104, the system evaluates the historical metrics along with the real-time metrics. Examples of the historical metrics evaluated by the system may include each of the labeling partners' average labeling accuracy, average turn-around time, and average pricing, both at an overall level and task-specific level (e.g., by grouping together similar types of tasks). Based on the real-time and historical metrics, the system identifies a labeling partner that is the most likely to produce the highest quality of work and in a timely-manner.

In an embodiment, at steps 105, the system offers the labeling task to the labeling partner determined as being the most suitable for handling the task. Once the task is offered to the labeling partner, the partner may (1) accept the task and notify the system of the acceptance, as described in step 106, (2) fail to respond to the offer within a time-limit placed by the system, as described in step 107, or (3) refuse the task and notify the system of the refusal, as described in step 108. The system provides a reliable, low-latency API gateway to the labeling partners, through which the partners are able to communicate their acceptance or refusal to the system. The API gateway also allows the partners to view additional information about the tasks offered to them. At step 109, if a labeling partner either refuses the task or does not reply within a set amount of time, the system removes the labeling partner from the selection pool and identifies another labeling partner that is suitable for handling the task. In an embodiment, the system may identify the subsequent labeling partner by re-evaluating the real-time and historical metrics of the labeling partners left in the selection pool. Alternatively, the system may identify the subsequent labeling partner based on the previous evaluation, for example, in situations where insignificant amount of time has passed since the previous evaluation. If the task offered to the labeling provider is accepted, at step 110, the system provides the customer's data and labeling instructions to the labeling partner. In an embodiment, the system may require the labeling partner to notify the system after getting started on the task (e.g., after assigning the task to appropriate annotators or after the annotators began working on the task). If the labeling partner does not notify the system within a set amount of time, the task may be offered to another labeling partner.

In an embodiment, the system may provide a dedicated storage database to each of the labeling providers, accessible by the system's API gateway or some type of a cloud infrastructure. At step 111, after completing the labeling task, the labeling partner uploads the labeled data into a corresponding storage database, allowing the system to gain access to it. Then, at step 112, the system evaluates the quality of the labeling partner's work using the system's internal tools. If the quality of the labeling partner's work is determined as not acceptable (e.g., accuracy issues), the system may provide the labeling partner an opportunity to remedy the issues. However, if the system determines that the labeling partner is unable to address the issues or the labeling partner notifies to the system that it is unable to address the issues, the system may provide the task to another labeling partner. At step 113, if the system determines that the quality of the labeling partner's work is acceptable, the labeling task is deemed complete and the labeled data is provided back to the customer (e.g., to a data storage dedicated to the customer).

In an embodiment, the system may store the labeled data in a historical database and index the data with a unique identification assigned to the labeling partner. The system may also index the data based on the type of data labeled, the type of the labeling task, and the quality of the labeled data (e.g., labeling accuracy, turn-around time.). The historical metrics evaluated in step 104 may correspond to the information stored in the historical database.

In an embodiment, data that is transferred within the computer-implemented marketplace may be encrypted. The encrypted data may be transferred to labeling partners and customers through HTTPS. In an embodiment, the system may provide the labeling partners with access to an API gateway hosted on a web server, and the web server may be capable of interacting with various message brokers and databases using various networking protocols, including remote procedure calls, HTTP 1, and HTTP 2.

2.2 Process with Data Curation

FIG. 2 is a flowchart that illustrates the system's processes for labeling a customer's data using a data preparation system with a data curation engine. These processes integrate the processes illustrated in FIG. 1 and further include, a data curation process in which small batches of data that are most likely to be effective in training the model are prioritized and labeled. Then, the system performs a training process in which the model is trained using the labeled data. Together, these processes are referred to as an experiment.

In an embodiment, at step 201, a customer uploads to the system labeling instructions, data to be labeled, and a model to be trained using the data. At step 202, the customer decides a labeling approach (e.g., ML-based approach, manual approach, or self-labeling approach). If the customer decides on a ML-based labeling approach, labeling partners that are not capable of providing ML-based labeling services may be eliminated during the selection process described in step 102. If the customer decides on a manual approach, labeling partners that are not capable of providing a manual labeling service may be eliminated during the selection process described in step 102. If the customer chooses a self-labeling approach (not illustrated in FIG. 2), the system may provide the data preparation, data curation, and training services without services related to the computer-implemented labeling database since the customer will be responsible for labeling the data.

In an embodiment, at step 203, the curation process begins, and at step 204, the customer's model and data are sent to the data curation engine. As discussed above, the system's data preparation and data curation services employ an Active Learning approach where portions of the data are prioritized so the portions that are most effective in training the model are labeled first. The curation engine analyzes the data and identifies a first batch of data that it believes will be effective in training the data. The first batch of data is provided to a labeling partner in a similar fashion as the processes described in FIG. 1. Once the labeling partner completes labeling the first batch of data, the labeled data is used to train the customer's model, as described in step 206. Then, the model's performance is evaluated. The system, for example, may evaluate the model's performance using an adversarial process that involves providing deceptive or faulty data to the model and evaluating how the model handles the data. At steps 207 and 208, if the system determines that the model's performance is acceptable, the system deems the model as sufficiently trained and provides the trained model and labeled data back to the customer (i.e., the experiment ends). The experiment may also end if the system determines that the customer's budget has ran out or if the model has reached its optimal performance. The system may determine that the model has reached its optimal performance if the unlabeled portions of the data (e.g., portions not yet provided to the labeling partner) have been identified by the data curation engine as redundant or irrelevant for training the model.

In an embodiment, at step 205, if the system determines that the model's performance is unacceptable, the next loop of the experiment begins. Going back to step 204, the data curation engine identifies the next batch of data and provides this batch to the labeling partner along with all of the previous batches of data. In an embodiment, the steps of identifying/selecting an optimal labeling partner (i.e., steps 102-108 within brackets 260) may be skipped for loops n>1, if the system determines that the same labeling partner should be used throughout the experiment. Alternatively, the steps within brackets 260 may be kept in place if the system determines that different labeling partners should be used within the same experiment. Once the labeling partner completes labeling a batch of the data, the experiment continues until the model's performance reaches an acceptable level, the budget is reached, or optimal performance has been achieved because the remaining data is determined as redundant or irrelevant for training the model.

3. Implementation Example—Hardware Overview

According to one embodiment, the techniques described herein are implemented by at least one computing device. The techniques may be implemented in whole or in part using a combination of at least one server computer and/or other computing devices that are coupled using a network, such as a packet data network. The computing devices may be hard-wired to perform the techniques, or may include digital electronic devices such as at least one application-specific integrated circuit (ASIC) or field programmable gate array (FPGA) that is persistently programmed to perform the techniques, or may include at least one general purpose hardware processor programmed to perform the techniques pursuant to program instructions in firmware, memory, other storage, or a combination. Such computing devices may also combine custom hard-wired logic, ASICs, or FPGAs with custom programming to accomplish the described techniques. The computing devices may be server computers, workstations, personal computers, portable computer systems, handheld devices, mobile computing devices, wearable devices, body mounted or implantable devices, smartphones, smart appliances, internetworking devices, autonomous or semi-autonomous devices such as robots or unmanned ground or aerial vehicles, any other electronic device that incorporates hard-wired and/or program logic to implement the described techniques, one or more virtual computing machines or instances in a data center, and/or a network of server computers and/or personal computers.

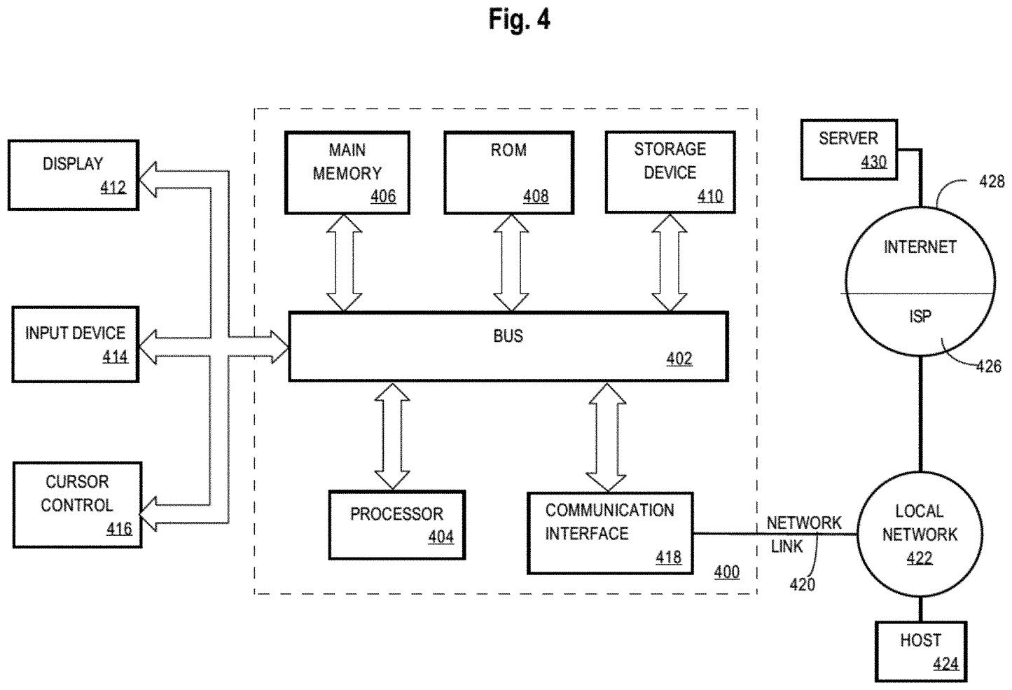

FIG. 4 is a block diagram that illustrates an example computer system with which an embodiment may be implemented. In the example of FIG. 4, a computer system 400 and instructions for implementing the disclosed technologies in hardware, software, or a combination of hardware and software, are represented schematically, for example as boxes and circles, at the same level of detail that is commonly used by persons of ordinary skill in the art to which this disclosure pertains for communicating about computer architecture and computer systems implementations.

Computer system 400 includes an input/output (I/O) subsystem 402 which may include a bus and/or other communication mechanism(s) for communicating information and/or instructions between the components of the computer system 400 over electronic signal paths. The I/O subsystem 402 may include an I/O controller, a memory controller, and at least one I/O port. The electronic signal paths are represented schematically in the drawings, for example as lines, unidirectional arrows, or bidirectional arrows.

At least one hardware processor 404 is coupled to I/O subsystem 402 for processing information and instructions. Hardware processor 404 may include, for example, a general-purpose microprocessor or microcontroller and/or a special-purpose microprocessor such as an embedded system or a graphics processing unit (GPU) or a digital signal processor or ARM processor. Processor 404 may comprise an integrated arithmetic logic unit (ALU) or may be coupled to a separate ALU.

Computer system 400 includes one or more units of memory 406, such as a main memory, which is coupled to I/O subsystem 402 for electronically digitally storing data and instructions to be executed by processor 404. Memory 406 may include volatile memory such as various forms of random-access memory (RAM) or another dynamic storage device. Memory 406 also may be used for storing temporary variables or other intermediate information during execution of instructions to be executed by processor 404. Such instructions, when stored in non-transitory computer-readable storage media accessible to processor 404, can render computer system 400 into a special-purpose machine that is customized to perform the operations specified in the instructions.

Computer system 400 further includes non-volatile memory such as read only memory (ROM) 408 or another static storage device coupled to I/O subsystem 402 for storing information and instructions for processor 404. The ROM 408 may include various forms of programmable ROM (PROM) such as erasable PROM (EPROM) or electrically erasable PROM (EEPROM). A unit of persistent storage 410 may include various forms of non-volatile RAM (NVRAM), such as FLASH memory, or solid-state storage, magnetic disk, or optical disk such as CD-ROM or DVD-ROM, and may be coupled to I/O subsystem 402 for storing information and instructions. Storage 410 is an example of a non-transitory computer-readable medium that may be used to store instructions and data which when executed by the processor 404 cause performing computer-implemented methods to execute the techniques herein.

The instructions in memory 406, ROM 408 or storage 410 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface, or text user interface; application software such as an office suite, internet access applications, design and manufacturing applications, graphics applications, audio applications, software engineering applications, educational applications, games, or miscellaneous applications. The instructions may implement a web server, web application server, or web client. The instructions may be organized as a presentation layer, application layer, and data storage layer such as a relational database system using structured query language (SQL) or no SQL, an object store, a graph database, a flat file system, or other data storage.

Computer system 400 may be coupled via I/O subsystem 402 to at least one output device 412. In one embodiment, output device 412 is a digital computer display. Examples of a display that may be used in various embodiments include a touch screen display or a light-emitting diode (LED) display or a liquid crystal display (LCD) or an e-paper display. Computer system 400 may include other type(s) of output devices 412, alternatively or in addition to a display device. Examples of other output devices 412 include printers, ticket printers, plotters, projectors, sound cards or video cards, speakers, buzzers or piezoelectric devices or other audible devices, lamps or LED or LCD indicators, haptic devices, actuators, or servos.

At least one input device 414 is coupled to I/O subsystem 402 for communicating signals, data, command selections, or gestures to processor 404. Examples of input devices 414 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, accelerometers, gyroscopes, and inertial measurement unit (IMU) sensors and/or various types of transceivers such as wireless, cellular or Wi-Fi, radio frequency (RF) or infrared (IR) transceivers, and Global Positioning System (GPS) transceivers.

Another type of input device is a control device 416, which may perform cursor control or other automated control functions such as navigation in a graphical interface on a display screen, alternatively or in addition to input functions. Control device 416 may be a touchpad, a mouse, a trackball, or cursor direction keys for communicating direction information and command selections to processor 404 and for controlling cursor movement on display 412. The input device may have at least two degrees of freedom in two axes, a first axis (e.g., x) and a second axis (e.g., y), that allows the device to specify positions in a plane. Another type of input device is a wired, wireless, or optical control device such as a joystick, wand, console, steering wheel, pedal, gearshift mechanism, or other type of control device. An input device 414 may include a combination of multiple different input devices, such as a video camera and a depth sensor.

In another embodiment, computer system 400 may comprise an interne of things (IoT) device in which one or more of the output device 412, input device 414, and control device 416 are omitted. Or, in such an embodiment, the input device 414 may comprise one or more cameras, motion detectors, thermometers, microphones, seismic detectors, other sensors or detectors, measurement devices or encoders and the output device 412 may comprise a special-purpose display such as a single-line LED or LCD display, one or more indicators, a display panel, a meter, a valve, a solenoid, an actuator, or a servo.

When computer system 400 is a mobile computing device, input device 414 may comprise a global positioning system (GPS) receiver coupled to a GPS module that is capable of triangulating to a plurality of GPS satellites, determining and generating geo-location or position data such as latitude-longitude values for a geophysical location of the computer system 400. Output device 412 may include hardware, software, firmware and interfaces for generating position reporting packets, notifications, pulse or heartbeat signals, or other recurring data transmissions that specify a position of the computer system 400, alone or in combination with other application-specific data, directed toward host 424 or server 430.

Computer system 400 may implement the techniques described herein using customized hard-wired logic, at least one ASIC or FPGA, firmware and/or program instructions or logic which when loaded and used or executed in combination with the computer system causes or programs the computer system to operate as a special-purpose machine. According to one embodiment, the techniques herein are performed by computer system 400 in response to processor 404 executing at least one sequence of at least one instruction contained in main memory 406. Such instructions may be read into main memory 406 from another storage medium, such as storage 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage 410. Volatile media includes dynamic memory, such as memory 406. Common forms of storage media include, for example, a hard disk, solid state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wire and fiber optics, including the wires that comprise a bus of I/O subsystem 402. Transmission media can also take the form of acoustic or light waves, such as those generated during radio-wave and infra-red data communications.

Various forms of media may be involved in carrying at least one sequence of at least one instruction to processor 404 for execution. For example, the instructions may initially be carried on a magnetic disk or solid-state drive of a remote computer. The remote computer can load the instructions into its dynamic memory and send the instructions over a communication link such as a fiber optic or coaxial cable or telephone line using a modem. A modem or router local to computer system 400 can receive the data on the communication link and convert the data to a format that can be read by computer system 400. For instance, a receiver such as a radio frequency antenna or an infrared detector can receive the data carried in a wireless or optical signal and appropriate circuitry can provide the data to I/O subsystem 402 such as place the data on a bus. I/O subsystem 402 carries the data to memory 406, from which processor 404 retrieves and executes the instructions. The instructions received by memory 406 may optionally be stored on storage 410 either before or after execution by processor 404.

Computer system 400 also includes a communication interface 418 coupled to bus 402. Communication interface 418 provides a two-way data communication coupling to network link(s) 420 that are directly or indirectly connected to at least one communication networks, such as a network 422 or a public or private cloud on the Internet. For example, communication interface 418 may be an Ethernet networking interface, integrated-services digital network (ISDN) card, cable modem, satellite modem, or a modem to provide a data communication connection to a corresponding type of communications line, for example an Ethernet cable or a metal cable of any kind or a fiber-optic line or a telephone line. Network 422 broadly represents a local area network (LAN), wide-area network (WAN), campus network, internetwork or any combination thereof. Communication interface 418 may comprise a LAN card to provide a data communication connection to a compatible LAN, or a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 418 sends and receives electrical, electromagnetic or optical signals over signal paths that carry digital data streams representing various types of information.

Network link 420 typically provides electrical, electromagnetic, or optical data communication directly or through at least one network to other data devices, using, for example, satellite, cellular, Wi-Fi, or BLUETOOTH technology. For example, network link 420 may provide a connection through a network 422 to a host computer 424.

Furthermore, network link 420 may provide a connection through network 422 or to other computing devices via internetworking devices and/or computers that are operated by an Internet Service Provider (ISP) 426. ISP 426 provides data communication services through a world-wide packet data communication network represented as internet 428. A server computer 430 may be coupled to internet 428. Server 430 broadly represents any computer, data center, virtual machine or virtual computing instance with or without a hypervisor, or computer executing a containerized program system such as DOCKER or KUBERNETES. Server 430 may represent an electronic digital service that is implemented using more than one computer or instance and that is accessed and used by transmitting web services requests, uniform resource locator (URL) strings with parameters in HTTP payloads, API calls, app services calls, or other service calls. Computer system 400 and server 430 may form elements of a distributed computing system that includes other computers, a processing cluster, server farm or other organization of computers that cooperate to perform tasks or execute applications or services. Server 430 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming, or other functions; data protocol instructions or stacks to implement TCP/IP, HTTP, or other communication protocols; file format processing instructions to parse or render files coded using HTML, XML, JPEG, MPEG, or PNG; user interface instructions to render or interpret commands for a graphical user interface (GUI), command-line interface, or text user interface; application software such as an office suite, internet access applications, design and manufacturing applications, graphics applications, audio applications, software engineering applications, educational applications, games, or miscellaneous applications. Server 430 may comprise a web application server that hosts a presentation layer, application layer, and data storage layer such as a relational database system using structured query language (SQL) or no SQL, an object store, a graph database, a flat file system, or other data storage.

Computer system 400 can send messages and receive data and instructions, including program code, through the network(s), network link 420, and communication interface 418. In the Internet example, a server 430 might transmit a requested code for an application program through Internet 428, ISP 426, local network 422, and communication interface 418. The received code may be executed by processor 404 as it is received, and/or stored in storage 410, or other non-volatile storage for later execution.

The execution of instructions as described in this section may implement a process in the form of an instance of a computer program that is being executed and consisting of program code and its current activity. Depending on the operating system (OS), a process may be made up of multiple threads of execution that execute instructions concurrently. In this context, a computer program is a passive collection of instructions, while a process may be the actual execution of those instructions. Several processes may be associated with the same program; for example, opening up several instances of the same program often means more than one process is being executed. Multitasking may be implemented to allow multiple processes to share processor 404. While each processor 404 or core of the processor executes a single task at a time, computer system 400 may be programmed to implement multitasking to allow each processor to switch between tasks that are being executed without having to wait for each task to finish. In an embodiment, switches may be performed when tasks perform input/output operations, when a task indicates that it can be switched, or on hardware interrupts. Time-sharing may be implemented to allow fast response for interactive user applications by rapidly performing context switches to provide the appearance of concurrent execution of multiple processes simultaneously. In an embodiment, for security and reliability, an operating system may prevent direct communication between independent processes, providing strictly mediated and controlled inter-process communication functionality.

4. Extensions and Alternatives

In the foregoing specification, embodiments of the invention have been described with reference to numerous specific details that may vary from implementation to implementation. Thus, the sole and exclusive indicator of what is the invention and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage, or attribute that is not expressly recited in a claim should limit the scope of such claim in any way. The specification and drawings are, accordingly, to be regarded in an illustrative rather than a restrictive sense.

What is claimed is:

1. A distributed computer system, comprising:
one or more hardware processors;
one or more non-transitory computer-readable storage media coupled to the one or more hardware processors and storing sequences of instructions which when executed using the one or more hardware processors cause the one or more hardware processors to execute:
receiving, from a user computer, a user dataset to be labeled and labeling instructions;
receiving and storing in a data schema of a provider metrics database, real-time and historical performance values and metrics for two or more labeling partners in a computer-implemented labeling marketplace, the real-time historical performance values and metrics being updated in the provider metrics database in real time as the two or more labeling partners complete labeling tasks for training data for machine learning models and transmit the real-time historical performance values and metrics from the two or more labeling partners to the system;
determining, based on the user dataset and the labeling instructions, a type of data of the user dataset and a type of labeling task represented in the labeling instructions;
identifying, from among the two or more labeling partners, a subset of one or more labeling partners that are able to label the type of data provided by the user computer or to perform the type of labeling task requested by the customer;
querying real-time and historical performance values and metrics stored in the provider metrics database for each labeling partner in the subset of one or more labeling partners to select a selected labeling partner optimal to perform the requested labeling task;
transmitting the user data and labeling instructions to the selected labeling partner;
receiving a labeled user dataset from the selected labeling partner after the selected labeling partner has conducted labeling of the user dataset;
evaluating a quality of the labeled user dataset and updating a record in the provider metrics database associated with the selected labeling partner to specify the quality;
transmitting the labeled user data to the user computer.

2. The distributed computer system of claim 1, the storage media further comprising sequences of instructions which when executed cause the one or more processors to execute the identifying by: transmitting, to a particular labeling partner among the two or more labeling partners, an offer to complete the type of labeling task, the offer comprising at least one deadline rule specifying when a particular action is required; in response to failing to receive a signal from the particular labeling partner specifying completion of the particular action, transmitting, to another particular labeling partner among the two or more labeling partners, the offer to complete the type of labeling task.

3. The distributed computer system of claim 2, the at least one deadline rule specifying one or more of: a limited time for the particular labeling partner to respond to the offer; a limited time for the particular labeling partner to begin the labeling task once the particular labeling partner has accepted the offer; a limited time for the particular labeling partner to complete the labeling task; or a limited time for the particular labeling partner to return the completed labeling task to the user computer.

4. The distributed computer system of claim 1, the storage media further comprising sequences of instructions which when executed cause the one or more processors to execute generating presentation instructions which when rendered using two or more labeling partner computers each respectively associated with the two or more labeling partners cause displaying an analytical dashboard, the analytical dashboard being programmed to track progress of annotators of the two or more labeling partners in real-time to assess the availability of the two or more labeling partners to receive a labeling task.

5. The distributed computer system of claim 4, the analytical dashboard being programmed to enable any of the two or more labeling partners to communicate an acceptance or a refusal of an offer.

6. The distributed computer system of claim 4, the analytical dashboard being programmed to provide task-level feedback to the two or more labeling partners specifying why a specific task was not offered.

7. The distributed computer system of claim 4, the storage media further comprising sequences of instructions which when executed cause the one or more processors to execute:
querying the provider metrics database using a plurality of queries that select aggregate pricing data, data labeling accuracy, and data labeling speed for each of the two or more labeling partners based on the real-time and historical performance values and metrics;
ranking each of the two or more labeling partners according to pricing data, data labeling accuracy, and data labeling speed;
generating presentation instructions which when rendered using two or more labeling partner computers each respectively associated with the two or more labeling partners cause displaying, in the analytical dashboard, a ranked list of the two or more labeling partners according to pricing data, data labeling accuracy, and data labeling speed.

8. The distributed computer system of claim 1, the data schema of the provider metrics database specifying that each record in the provider metrics database comprises fields for: types of tasks that a particular labeling partners can label; an available clearance of the labeling partners; one or more names of annotators that a particular labeling partner may utilize;
location values of locations of annotators that the particular labeling partner may utilize; types of labeling tasks that annotators of the particular labeling partner are capable of performing;
types of tasks that annotators of the particular labeling partner prefer to work on; values of average speed and accuracy of the annotators of the labeling; and a desired workload of annotators of the particular labeling partner;
the storage media further comprising sequences of instructions which when executed cause the one or more processors to execute: receiving from each of the two or more labeling partners, values for each of the fields of the schema of the provider metrics database.

9. The distributed computer system of claim 1, the storage media further comprising sequences of instructions which when executed cause the one or more processors to execute:
updating the provider metrics database in real time as the two or more labeling partners complete labeling tasks for training data for machine learning models and transmit the real-time historical performance values and metrics from the two or more labeling partners to the system, the real-time historical performance values and metrics comprising: an average labeling accuracy of the labeling partners and their annotators; an average labeling speed of the labeling partners and their annotators; a typical availability of the labeling partners and their annotators; an average price of the labeling partners; a time since the labeling partners and their annotators were last offered a task; a time of idle of the labeling partners and their annotators; an average time taken by the labeling partners to resolve labeling issues identified by a quality control process of the recommendation computer system; an average number of iterations required by the labeling partners and their annotators to resolve a labeling issue; an average response time of the labeling partners and their annotators to an inquiry from the recommendation computer system.

10. The distributed computer system of claim 1, the storage media further comprising sequences of instructions which when executed cause the one or more processors to execute the identifying by multi-objective optimization based on: an average time required by the labeling partners to complete and return a task; an average labeling accuracy of the labeling partners; an average price of the labeling partners; an average revenue of the labeling partners over a given period of time; a number of tasks previously offered to the labeling partners; types of tasks previously offered to the labeling partners.

11. The distributed computer system of claim 10, the optimization process being programmed using any of a Dantzig simplex algorithm, combinatorial algorithms, or quantum optimization algorithms.

12. The distributed computer system of claim 1, the storage media further comprising sequences of instructions which when executed cause the one or more processors to execute active learning to train a machine learning model by:
initiating an experiment comprising identifying a first batch of data from the user dataset, transmitting the first batch of the user dataset and the labeling instructions to the selected labeling partner, receiving a labeled first batch of the user dataset from the selected labeling partner, and training the machine learning model with the labeled first batch of the user dataset;
evaluating a performance of the machine learning model using an evaluation dataset to produce an evaluation metric;
repeating the experiment using a second batch of data selected from the user dataset until the performance metric is greater than a specified performance threshold.

13. The distributed computer system of claim 12, the storage media further comprising sequences of instructions which when executed cause the one or more processors to evaluate the performance of the machine learning model by using deceptive or faulty data.

14. The distributed computer system of claim 12, the storage media further comprising sequences of instructions which when executed cause the one or more processors to execute one or more of brute-force active learning, skip-loop active learning, or ranking-based active learning.

15. A data processing method comprising:
receiving, from a user computer, a user dataset to be labeled and labeling instructions;
receiving and storing in a data schema of a provider metrics database, real-time and historical performance values and metrics for three or more labeling partners in a computer-implemented labeling marketplace, the real-time historical performance values and metrics being updated in the provider metrics database in real time as the three or more labeling partners complete labeling tasks for training data for machine learning models and transmit the real-time historical performance values and metrics from the three or more labeling partners to the system;
determining, based on the user dataset and the labeling instructions, a type of data of the user dataset and a type of labeling task represented in the labeling instructions;
identifying, from among the three or more labeling partners, a subset of at least three labeling partners that are able to label the type of data provided by the user computer or to perform the type of labeling task requested by the customer and generating and transmitting, to the user computer, presentation instructions which when rendered using the user computer cause displaying at the user computer a graphical user interface comprising an ordered list of the at least three labeling partners, the at least three labeling partners being ordered in the graphical user interface based on highest accuracy, fastest time, and/or lowest price based on queries to the provider metrics database that yield result sets of values for accuracy, time, and/or price for all the three or more labeling partners in the marketplace;
querying real-time and historical performance values and metrics stored in the provider metrics database for each labeling partner in the subset of one or more labeling partners to select a selected labeling partner optimal to perform the requested labeling task;
transmitting the user data and labeling instructions to the selected labeling partner;
receiving a labeled user dataset from the selected labeling partner after the selected labeling partner has conducted labeling of the user dataset;
evaluating a quality of the labeled user dataset and updating a record in the provider metrics database associated with the selected labeling partner to specify the quality;
transmitting the labeled user data to the user computer.

16. The method of claim 15, further comprising executing the identifying by:
transmitting, to a particular labeling partner among the three or more labeling partners, an offer to complete the type of labeling task, the offer comprising at least one deadline rule specifying when a particular action is required; in response to failing to receive a signal from the particular labeling partner specifying completion of the particular action, transmitting, to another particular labeling partner among the three or more labeling partners, the offer to complete the type of labeling task.

17. The method of claim 16, the at least one deadline rule specifying one or more of: a limited time for the particular labeling partner to respond to the offer; a limited time for the particular labeling partner to begin the labeling task once the particular labeling partner has accepted the offer; a limited time for the particular labeling partner to complete the labeling task; or a limited time for the particular labeling partner to return the completed labeling task to the user computer.

18. The method of claim 15, further comprising generating presentation instructions which when rendered using three or more labeling partner computers each respectively associated with the three or more labeling partners cause displaying an analytical dashboard, the analytical dashboard being programmed to track progress of annotators of the three or more labeling partners in real-time to assess the availability of the three or more labeling partners to receive a labeling task.

19. The method of claim 18, the analytical dashboard being programmed to enable any of the three or more labeling partners to communicate an acceptance or a refusal of an offer.

20. The method of claim 18, the analytical dashboard being programmed to provide task-level feedback to the three or more labeling partners specifying why a specific task was not offered.
